(19) United States
(12) Patent Application Publication
(10) Pub. No.: US 2016/0147483 A1
(43) Pub. Date: May 26, 2016

(54) IMAGE PROCESSING SYSTEM, IMAGE FORMING APPARATUS, AND IMAGE PROCESSING METHOD

(71) Applicant: Mitsuo NAKAMURA, Kanagawa (JP)

(72) Inventor: Mitsuo NAKAMURA, Kanagawa (JP)

(73) Assignee: Ricoh Company, Limited, Tokyo (JP)

(21) Appl. No.: 14/950,462

(22) Filed: Nov. 24, 2015

(30) Foreign Application Priority Data
Nov. 26, 2014 (JP) 2014-239078

(51) Int. Cl. G06F 3/12; H04N 1/00

(52) U.S. Cl. CPC G06F 3/1204; H04N 1/00244; H04N 1/00464; G06F 3/1254; G06F 3/1259; H04N 2201/0094

(57) ABSTRACT

An image processing system causes a display unit to display, as an image, display information received from an external device and causes a print unit to print the displayed image. The image processing system includes a storage configured to store print setting information that defines print conditions to be applied when performing printing on a recording medium; a changer configured to change content of the display information according to the print setting information stored in the storage; and a generator configured to generate a print image to be fed to the print unit, using the changed display information.

### CROSS-REFERENCE TO RELATED APPLICATION

The present application claims priority to and incorporates by reference the entire contents of Japanese Patent Application No. 2014-239078 filed in Japan on Nov. 26, 2014.

### BACKGROUND OF THE INVENTION

1. Field of the Invention

The present invention relates to an image processing system, an image forming apparatus, and an image processing method.

2. Description of the Related Art

In the WWW (World Wide Web), which is normally used in the Internet, a web page is a basic unit of information; a web server carries out web page management including storing, publishing, and delivering the web page. A web client uses the web page by submitting a request for the web page to the web server and receives the requested web page from the web server. The web client contains a web browser, which allows a user to view the content of the web page by displaying the content on a screen by making use of the web browser.

For example, web pages are generally created without taking paper sizes into consideration. Accordingly, when a web page is printed on A3 or larger size paper using a wide-format printer capable of printing on large size paper of A3 size or larger, large blank areas can be undesirably left. In addition, printing a web page containing a web banner, which is displayed to attract traffic to another web site, can undesirably produce a faulty image where, for example, a necessary portion of the web page is hidden by the web banner.

However, conventional techniques have a problem that it is difficult to make appropriate settings including a paper size and a reduction/enlargement percentage, and therefore it is not easy to make the settings so that an image of a web page can be printed as intended by a creator of the web page.

Therefore, there is a need for a system, a method, and the like for enabling printing an image of displayed information, such as a web page, as intended by a creator of the displayed information without requiring a user to make print settings.

### SUMMARY OF THE INVENTION

It is an object of the present invention to at least partially solve the problems in the conventional technology.

According to an embodiment, there is provided an image processing system for causing a display unit to display, as an image, display information received from an external device and causing a print unit to print the displayed image. The image processing system includes a storage configured to store print setting information that defines print conditions to be applied when performing printing on a recording medium; a changer configured to change content of the display information according to the print setting information stored in the storage; and a generator configured to generate a print image to be fed to the print unit, using the changed display information.

According to another embodiment, there is provided an image forming apparatus that includes the image processing system according to the above embodiment; and the print unit configured to perform printing in accordance with the print image fed from the image processing system.

According to still another embodiment, there is provided a method for causing a display unit to display, as an image, display information received from an external device and causing a print unit to print the displayed image. The method includes changing content of the display information stored in a storage according to print setting information that defines print conditions to be applied when performing printing on a recording medium; and generating a print image to be fed to the print unit, using the changed display information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a network system including an information processing apparatus serving as an image processing system;

FIG. 2 is a diagram illustrating a network system including an MFP internally including an image processing system;

FIG. 3 is a diagram illustrating a hardware structure of the MFP illustrated in FIG. 2;

FIG. 4 is a functional block diagram of the MFP illustrated in FIG. 3;

FIG. 5 illustrates an example of a print image with content of a CSS file unchanged and an example of a print image with the content changed;

FIG. 6 illustrates another example of a print image with content of a CSS file unchanged and another example of a print image with the content changed;

FIG. 7 is a sequence diagram illustrating a process performed by the MFP illustrated in FIG. 2 and a server apparatus serving as an external device; and

FIG. 8 is a diagram illustrating an example of web content stored in the server apparatus.

### DETAILED DESCRIPTION OF THE PREFERRED EMBODIMENTS

Exemplary embodiments of the present invention are described below with reference to the accompanying drawings.

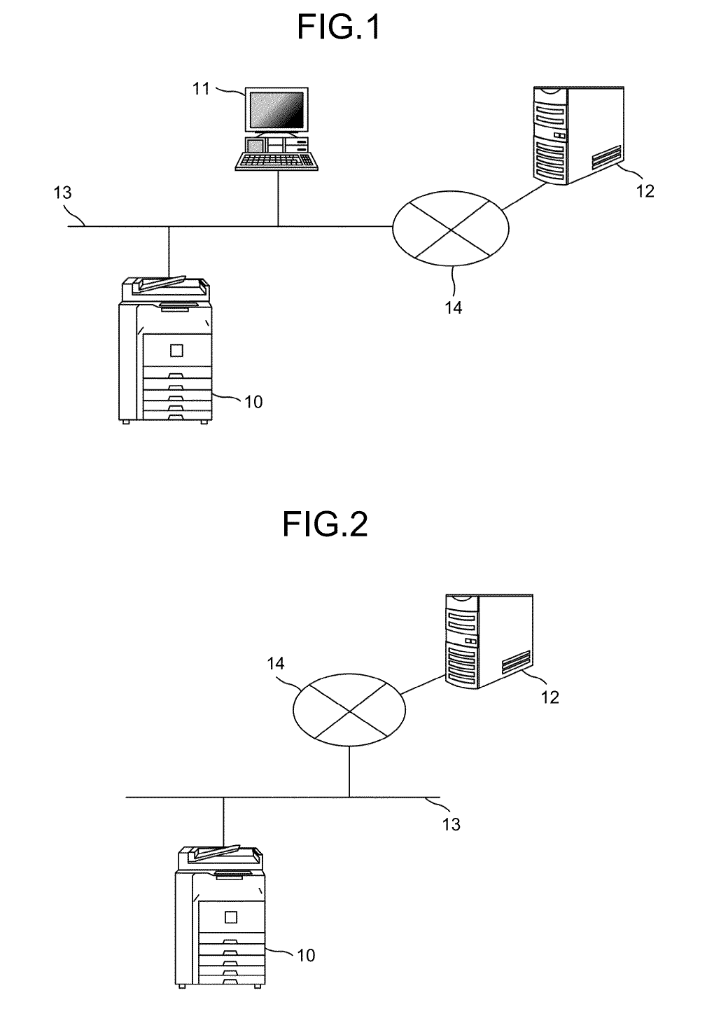

FIG. 1 is a diagram illustrating a network system including an information processing apparatus serving as an image processing system. The network system includes an MFP (multi-function peripheral) 10 serving as an image forming apparatus, an information processing apparatus 11, and a server apparatus 12 serving as an external device. The MFP 10 and the information processing apparatus 11 are connected to a network 13 such as a LAN (local area network). The server apparatus 12 is connected to Internet 14, to which the network 13 is connected.

The MFP 10 has a plurality of functions such as a scanner function of reading in an original document or the like, a printing function of printing an image, a copying function, a facsimile transmission/reception function, and a communication function. The information processing apparatus 11 and the server apparatus 12, each also having the communication function, can exchange data and the like with each other. The information processing apparatus 11 contains a web browser. The server apparatus 12 includes a web server, which can respond to the web browser. The server apparatus 12 contains a plurality of web sites, which are a plurality of pieces of web content, as information to be displayed (hereinafter, “display information”). The web site is configured such that a user can visit each web page from a top page by following a corresponding link.

The information processing apparatus 11 causes the web browser to submit a request for a piece of web content (hereinafter, sometimes simply referred to as “web content”) to the web server of the server apparatus 12 via the network 13 and the Internet 14. The web server of the server apparatus 12 retrieves the requested web content from the plurality of pieces of web content stored in the server apparatus 12 and delivers the retrieved web content to the web browser. The information processing apparatus 11 includes a display unit. The web browser causes the display unit to display the web content received from the web server. A user of the information processing apparatus 11 can thus view the web content.

The user can cause a certain web page to be displayed by following a link from a top page provided by the web content by using an input unit such as a keyboard, a mouse, or the like included in the information processing apparatus 11. When the user desires to print the displayed web page, the user instructs the information processing apparatus 11 to perform printing. Upon receiving the instruction, the information processing apparatus 11 generates an image to be printed (hereinafter, “print image”) for use by the MFP 10 in printing and feeds a print request containing the print image to the MFP 10. The MFP 10 performs printing based on the print image contained in the print request fed from the information processing apparatus 11.

Although the MFP 10 is illustrated as an example of a printing apparatus in FIG. 1, alternatively, the printing apparatus may be a printer having only the printing function. Any equipment may be used as the information processing apparatus 11 so long as the equipment contains a web browser and can perform processing including sending a request for web content to the server apparatus 12, receiving the web content, and causing the MFP 10 to perform printing upon receiving a print instruction. A PC (personal computer), a tablet terminal, a smartphone, a PDA (personal digital assistant), a projector, or an interactive whiteboard, for example, may be used as the information processing apparatus 11.

Although FIG. 1 illustrates the example where the Internet 14 is used, alternatively, a WAN (wide area network) or the like may be used in lieu of the Internet 14. The network 13 may be either a wired network or a wireless network such as a Wi-Fi (registered trademark) network. When a WAN is adopted, the WAN also may be either a wired network or a wireless network.

Although the server apparatus 12 is connected to the Internet 14 in FIG. 1, the server apparatus 12 may alternatively be connected to another network connected to the Internet 14 or, further alternatively, may be connected to the network 13. Other equipment, than the information processing apparatus 11 and the server apparatus 12, may be connected to the network 13 and/or the Internet 14.

The image processing system in the example illustrated FIG. 1 is implemented in the information processing apparatus 11, which is an independent, a single piece of equipment. Alternatively, a form, in which the function of the image processing system is split among two or more pieces of equipment, may be adopted. Further alternatively, a form, in which the MFP 10 internally includes the image processing system as illustrated in FIG. 2, may be adopted. In the example illustrated in FIG. 2, only the MFP 10 is connected to the network 13; the MFP 10 contains the web browser. Accordingly, the MFP 10 acquires a piece of web content from the web server of the server apparatus 12 by submitting a request for the web content to the web server by using the web browser. The MFP 10 includes a display screen, such as an operating panel, and displays the received web content on the display screen. Each piece of web content includes a top page and one or more web pages. The top page is displayed first.

A user can cause a desired web page to be displayed by operating an operating button(s) or an operating panel provided in the MFP 10. If the user desires to print the thus-displayed web page, the user gives an instruction to print the web page by pressing, for example, a PRINT button. Upon receiving the print instruction, the MFP 10 prints the displayed web page.

Also in the example illustrated in FIG. 2, a WAN may be used in lieu of the Internet 14; the network 13 may be either a wired network or a wireless network. The server apparatus 12 may be connected to another network connected to the Internet 14 or, further alternatively, may be connected to the network 13. Other equipment, than the MFP 10 and the server apparatus 12, may be connected to the network 13 and/or the Internet 14. The display unit is not limited to the operating panel and may alternatively be a separate display or the like connected to the MFP 10 with a cable or the like. In the description below, it is assumed that the image processing system is internally included in the MFP 10, and the network system is made up of the MFP 10 and the server apparatus 12 as illustrated in FIG. 2.

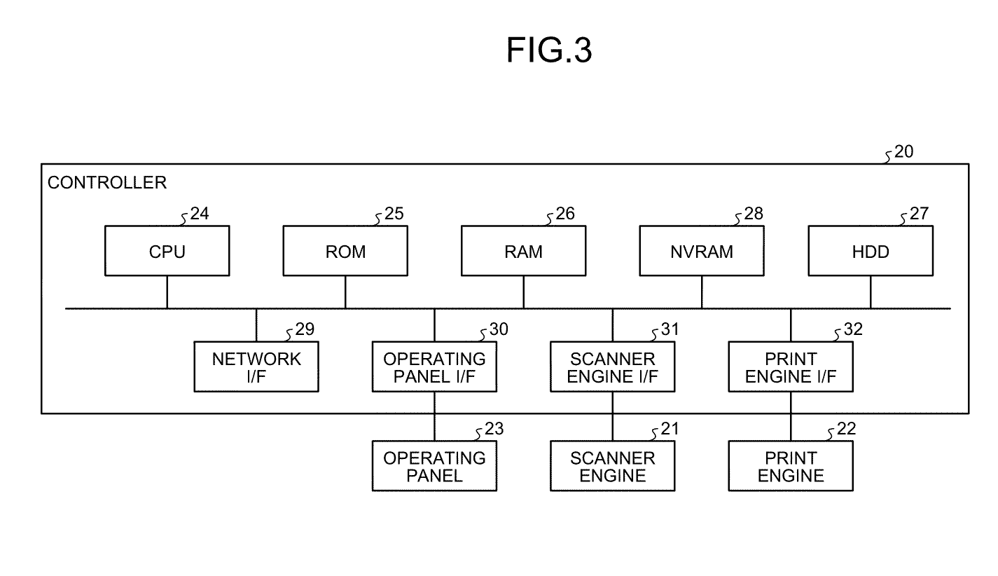

FIG. 3 is a diagram illustrating an example of a hardware structure of the MFP 10. The MFP 10 includes a controller 20, a scanner engine 21, a print engine 22, and an operating panel 23. The scanner engine 21 reads in an original document (hereinafter, “original”) or the like. The print engine 22 prints the read-in image and the like. The scanner engine 21 includes a light source and a photoelectric converter. The light source irradiates an original with light to read in the original. The photoelectric converter receives light reflected off the original or light transmitted through the original and converts the light into electric signals. The photoelectric converter may be either a CCD (charge coupled device) image sensor or a CMOS (complementary metal oxide semiconductor) image sensor. The scanner engine 21 may further include a plurality of reflecting mirrors, a condenser lens, and an A/D converter.

The print engine 22 may be any one of an electrophotographic printer, an inkjet printer, and a printer of another system. A hardware structure of the print engine 22 is described below on an assumption that an electrophotographic printer is used as the print engine 22. The print engine 22 includes a writing unit, a photoconductor drum, a developing unit, a transfer unit, a conveying belt, a fixing unit, a paper feeding unit, and a paper ejection unit.

The writing unit acquires a print image as image data and forms an image on the surface of the photoconductor drum by irradiating the surface with light in accordance with the image data. The developing unit deposits toner onto the image formed on the surface of the photoconductor drum, thereby forming a toner image. The paper feeding unit supplies paper onto the conveying belt. The transfer unit presses the paper against the photoconductor drum, thereby transferring the toner image onto the paper. The fixing unit fixes the toner onto the paper by applying heat and pressure to the toner image transferred onto the paper. The paper ejection unit ejects the paper where the toner is fixed.

The operating panel 23 has functions as the display unit and the input unit. The operating panel 23 accepts input data and instructions from a user and displays web content, a job progress status, error indication, or the like. Examples of the input data include a setting value for print settings and a facsimile number. The job progress status is information indicating current statuses of jobs including a scan job, a print job, and a copy job. More specifically, the job progress status is information indicating that the job is in progress, the job is completed, the job is terminated, or the like.

The controller 20 includes a CPU (central processing unit) 24, a ROM (read only memory) 25, a RAM (random access memory) 26, an HDD (hard disk drive) 27, an NVRAM (non-volatile random access memory) 28, a network I/F 29, an operating panel I/F 30, a scanner engine I/F 31, and a print engine I/F 32 to provide overall control of the MFP 10. The CPU 24 loads program instructions (hereinafter, “program”) stored in the ROM 25 or the HDD 27 and executes the program. The CPU 24 executes the program by using print setting information and/or the like stored in the NVRAM 28 as required. More specifically, the CPU 24 uses the print setting information in the following manner. The CPU 24 loads a setting value(s) into the RAM 26 and executes the program loaded into the RAM 26 while using the setting value(s) loaded into the RAM 26. The program includes OS (operating system), a boot program, firmware, application programs for implementing the functions, various types of drivers, and programs for performing the process described above of submitting a request for web content, receiving the web content, causing the web content to be displayed, and generating a print image upon receiving a print instruction.

The RAM 26 provides a work space to be used by the CPU 24 in executing the program and, furthermore, is used as a page memory for generating the print image. The HDD 27 further stores image data representing an image(s) read-in by the scanner engine 21.

The network I/F 29 is connected to the network 13 illustrated in FIG. 1 or 2 to enable communication with the server apparatus 12 via the network 13 and the Internet 14. The MFP 10 can therefore submit a request for web content to the server apparatus 12 via the network I/F 29 and receive the web content from the server apparatus 12 via the network I/F 29.

The operating panel I/F 30 connects the controller 20 to the operating panel 23 to accept information and instructions entered to the operating panel 23. Furthermore, the operating panel I/F 30 sends display information to the operating panel 23 to cause the display information to be displayed on the operating panel 23. Examples of the display information include the above-described display information such as a web page, and the information such as a job progress status and error indication.

The scanner engine I/F 31 sends an instruction to read an original to the scanner engine 21 and accepts inputs of information about a scan job and an image read-in by the scanner engine 21. The print engine I/F 32 sends a print request containing a print image to the print engine 22 and accepts information about a print job.

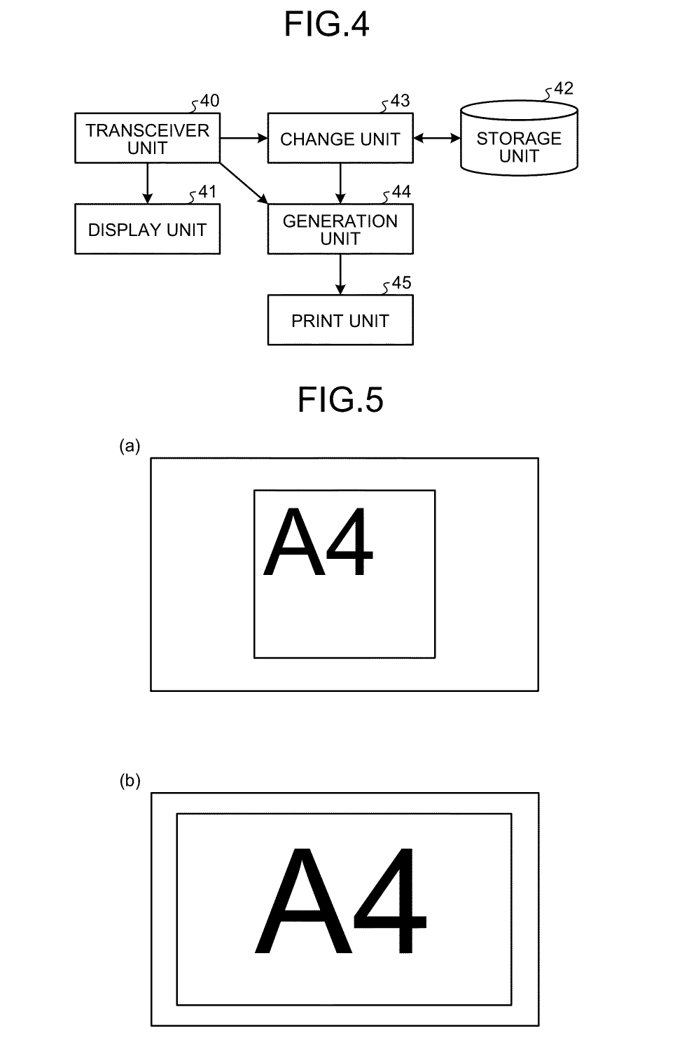

FIG. 4 is a functional block diagram of the MFP 10. The MFP 10 includes a plurality of functional units implemented by the CPU 24 by executing the above-described program for generating a print image and implemented in the print engine 22 and the like. The MFP 10 includes, as the functional units, a transceiver unit 40, a display unit 41, a storage unit 42, a change unit 43, a generation unit 44, and a print unit 45.

The transceiver unit 40 submits a request for web content to the server apparatus 12 illustrated in FIG. 1 or 2 and receives the web content therefrom. The MFP 10 can carry out communication with the server apparatus 12 by using, for example, HTTP (HyperText Transfer Protocol) as a communication protocol. The MFP 10 can send an HTTP GET request to the server apparatus 12 and acquire web content as a response (HTTP response) to the request by carrying out the communication using the communication protocol. An HTTP GET request is a request for acquiring information using the GET method. Note that the method described above is only an example and any other method can be used so long as web content can be acquired using the method.

The display unit 41 displays the web content received by the transceiver unit 40. The display unit 41 displays a top page of the web content first. When a link, which is contained in the top page, to a web page is selected by a user, the display unit 41 displays the selected web page.

The storage unit 42, as which the NVRAM 28 is used, for example, stores therein print setting information defining print conditions to be applied when performing printing on a recording medium such as paper. The print conditions can be entered and set by a user by using the operating panel 23. The print conditions may include, for example, information about a font type, a font size, a paper type, a paper size, a reduction/enlargement percentage, position of text and/or image, destination, color/monochrome, page layout, whether or not duplex printing is to be applied, margins, and presence/absence of a web banner. The destination is a shipping destination of the MFP 10. If the MFP 10 is to be shipped to the U.S., the destination is the U.S., while if the MFP 10 is to be shipped to China, the destination is China. Note that the destination is not necessarily a country; the destination may be a state, a region, a city, or the like. In other words, the information about the destination is localization for the MFP 10.

The change unit 43 changes web content using the print setting information stored in the storage unit 42. Examples of the content changed by the change unit 43 include content of a CSS (cascading style sheets) file contained in the web content. A CSS file is a file described in a language for defining a style of a web page. A CSS file defines a size, position, and the like (e.g., color, font, and layout) of an image(s) in a web page such as an HTTP document exchanged using the HTTP. The change unit 43 changes the color, the font, the layout, and the like defined by the CSS file to information of color, font, layout, and the like specified by the print setting information.

Although only the color, the font, and the layout have been described above, a paper size, a reduction/enlargement percentage, whether or not to additionally display a web banner as being overlaid on an image, and the like can also be changed, thereby making settings to an appropriate paper size and an appropriate reduction/enlargement percentage and causing no web banner to be displayed. Other settings than those described above can also be changed.

The generation unit 44 generates a print image to be fed to the print unit 45 using the web content containing the CSS file changed by the change unit 43. The generation unit 44 performs, based on information defined by the CSS file, rendering for a wide-format printer and/or rendering of deleting a web banner(s).

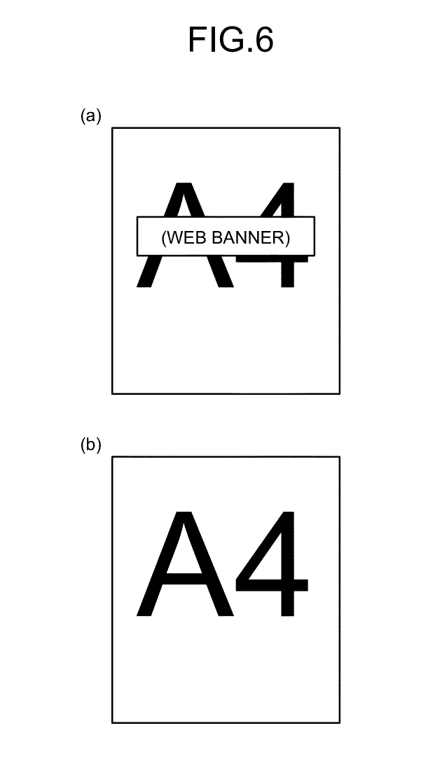

The generation unit 44 feeds a print request containing the generated print image to the print unit 45. The print unit 45 receives the print request from the generation unit 44 and performs printing in accordance with the print image contained in the print request. The print unit 45 produces a printout by printing such an image as that illustrated in (b) in FIG. 5 or (b) in FIG. 6 on paper.

FIG. 5 illustrates an example of a print image printed on wide-format paper with content of a CSS file unchanged and an example printed with the content changed. In FIG. 5, (a) illustrates the example, in which the content of the CSS file is not changed; and (b) illustrates the example, in which the content is changed. When the content is not changed, as illustrated in (a) in FIG. 5, an image having large white margins is printed at a position a little closer to the top than to the bottom. Accordingly, this image can be judged as a failed image. In contrast, when the content is changed, as illustrated in (b) in FIG. 5, an image is printed in an appropriate size and at an appropriate position in relation to the wide-format paper.

FIG. 6 illustrates an example of a print image containing a web banner printed with content of a CSS file unchanged and an example printed with the content changed. In FIG. 6, (a) illustrates the example, in which the content of the CSS file is not changed; and (b) illustrates the example, in which the content is changed. When the content is not changed, a faulty image, in which a necessary text is hidden, is printed because the web banner is printed on the necessary text “A4” as illustrated in (a) in FIG. 6. In contrast, when the content is changed, the web banner is deleted, and only the necessary text “A4” is printed as illustrated in (b) in FIG. 6.

Thus, printing web content with optimum print conditions for the MFP 10 can be achieved by setting the optimum print conditions, storing the print conditions in the storage unit 42 as print setting information, and changing, by the change unit 43, to the content. As a result, an image having neither unnecessary white margins nor a web banner or the like can be printed as intended by a creator of the web content while obviating the need for setting a paper size, a reduction/enlargement percentage, and the like from a user.

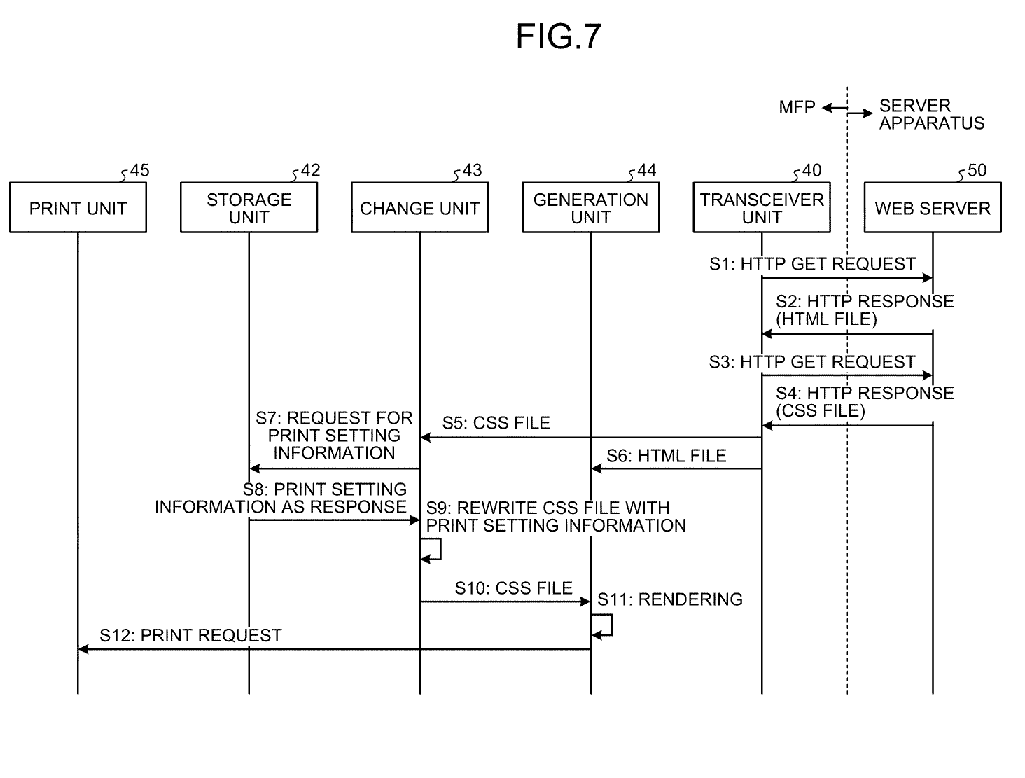

The processes performed by the MFP 10 are described in detail below with reference to the sequence diagram illustrated in FIG. 7. The MFP 10 includes the transceiver unit 40, the storage unit 42, the change unit 43, the generation unit 44, and the print unit 45 and carries out communication with a web server 50 of the server apparatus 12. The transceiver unit 40 transmits an HTTP GET request to the web server by using the HTTP as communication protocol (S1). The transceiver unit 40 receives, as a response to the HTTP GET request, an HTTP response (S2). The HTTP response received at this time is an HTML file of the web content. An HTML file contains structured document data and is described using special character strings referred to as tags. An HTML file also contains information such as an image and a link to another document.

After receiving the HTML file, the transceiver unit 40 transmits an HTTP GET request to the web server (S3) and receives, as a response to the HTTP GET request, an HTTP response (S4). The request to be transmitted at S3 is a request for a CSS file. Accordingly, the transceiver unit 40 receives the CSS file as the HTTP response. The transceiver unit 40 transmits the received CSS file to the change unit 43 (S5) and transmits the HTML file to the generation unit 44 (S6). Upon receiving the CSS file, the change unit 43 submits a request for print setting information to the storage unit 42 (S7) and acquires the print setting information from the storage unit 42 (S8).

The change unit 43 rewrites the CSS file in accordance with the print setting information (S9) and sends the rewritten CSS file, the content of which is changed, to the generation unit 44 (S10). For instance, if the CSS file defines that a web banner(s) is to be displayed, while the print setting information defines that no web banner is to be displayed, the CSS file is changed so as to define that no web banner is to be displayed. If a reduction/enlargement percentage defined by the CSS file is, e.g., 120%, which is inappropriate, while a reduction/enlargement percentage defined by the print setting information is 200%, which is suitable for paper size, the reduction/enlargement percentage of CSS file is changed to 200%. The generation unit 44 causes a rendering program to perform rendering using the changed CSS file and the HTML file, thereby generating a print image (S11). The generation unit 44 feeds a print request containing the generated print image to the print unit 45. The print unit 45 performs printing in accordance with the print image (S12).

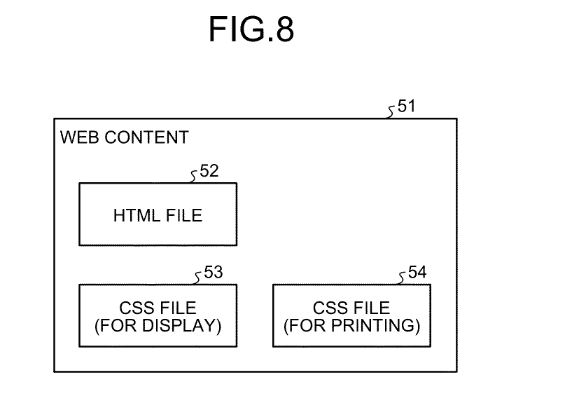

Creators of web pages can create the web pages with consideration given to printing. Accordingly, it is possible to create a piece of web content 51 (hereinafter, “web content 51”) so as to contain an HTML file 52 and two CSS files denoted by 53 and 54 as illustrated in FIG. 8. The CSS file 53 is a file to be used when displaying the web content 51 on the display unit 41. The CSS file 54 is a file to be used when generating a print image.

It is possible to provide the CSS file 54 in advance in this manner. However, it is substantially impossible to make settings to support features, including paper size and monochrome/color, of every printing apparatus that can possibly be used by users. For this reason, some printing apparatuses can undesirably produce such an image as that illustrated in (a) in FIG. 5 or (b) in FIG. 6 if the printing apparatus performs printing using the settings defined by the CSS file 54 contained in the web content 51. However, by performing the above-described process of rewriting the CSS file with the print setting information, even such a printing apparatus can output an appropriate print image.

The storage unit 42, in which appropriate print setting information is to be stored, does not necessarily store one piece of the print setting information but can store a plurality of pieces of the print setting information. Selection of one piece among the plurality of pieces of the print setting information may be made either by a user or automatically. To make the selection automatically, a selection unit for making the selection may be additionally provided.

The selection unit can be configured to select the one piece of the print setting information to be used depending on designation of paper, e.g., A3 paper or A4 paper. This is because if paper for use in printing varies, the size, quality, and the like of the paper vary, which causes color, reduction/enlargement percentage, and the like to also vary. The selection unit can determine which one piece of the print setting information is to be selected by acquiring information about designation of paper, which is set by a user when issuing a print instruction, or default paper designation. For instance, if it is designated that A3 paper is to be used, the selection unit can select one piece of the print setting information for printing on A3 paper.

The selection unit may select the one piece of the print setting information to be used depending on content represented by data of the web content. For instance, the selection unit can be configured to select, for an image containing only texts, a print setting information piece according to which monochrome printing is performed but select, for an image containing a picture, a photo, or the like, a print setting information piece according to which color printing is performed. Note that the above-described methods for selecting a print setting information piece are only exemplary and the selection method is not limited thereto.

Information about a destination, which may be a country or the like where the MFP 10 is shipped, of the MFP 10 is set and registered. Because paper size and the like can vary from one destination from another, it is desirable to change the print setting information depending on the destination. To satisfy the desire, the MFP 10 is configured to be capable of change the print setting information to be used depending on the registered information about the destination. Paper sizes can vary from one country from another in the following manner, for example. In Japan, paper of paper sizes, such as A3 and A4, of the international standard are commonly used, whereas paper of the inch-based letter size is commonly used in the U.S. and the like.

By automatically changing the print setting information depending on paper and content represented by data and, furthermore, depending on the destination in this manner, an appropriate print image can be printed to produce a printout without requiring a user to make print settings. Accordingly, an image of web content can be printed as intended by a creator of the web content.

All such embodiments fall within the scope of the invention so long as the effects and advantages of the present invention are achieved. Accordingly, a computer-readable storage medium storing the program therein, a network system including the server apparatus, and the like can also be provided.

According to an embodiment, an image of displayed information can be printed as intended by a creator of the displayed information without requiring a user to make print settings.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing system for causing a display unit to display, as an image, display information received from an external device and causing a print unit to print the displayed image, the image processing system comprising:
a storage configured to store print setting information that defines print conditions to be applied when performing printing on a recording medium;
a changer configured to change content of the display information according to the print setting information stored in the storage; and
a generator configured to generate a print image to be fed to the print unit, using the changed display information.

2. The image processing system according to claim 1,
wherein the storage stores a plurality of pieces of the print setting information, and
the changer changes the content of the display information according to a piece of the print setting information selected by a user among the plurality of pieces of the print setting information.

3. The image processing system according to claim 1, wherein
the storage stores a plurality of pieces of the print setting information, and
the image processing system further comprises a selection unit configured to select one piece of the print setting information among the plurality of pieces of the print setting information stored in the storage depending on designation of the recording medium.

4. The image processing system according to claim 1, wherein
the storage stores a plurality of pieces of the print setting information, and
the image processing system further comprises a selection unit configured to select one piece of the print setting information among the plurality of pieces of the print setting information stored in the storage depending on the content of the display information.

5. The image processing system according to claim 1, wherein the print setting information contains information about at least size of the image, position of the image, and presence or absence of an additional image to be displayed as being overlaid on the image.

6. The image processing system according to claim 1, further comprising an acquirer configured to submit a request for the display information to the external device and acquire the display information from the external device.

7. An image forming apparatus comprising:
the image processing system according to claim 1; and
the print unit configured to perform printing in accordance with the print image fed from the image processing system.

8. The image forming apparatus according to claim 7, wherein the image forming apparatus changes the print setting information depending on localization information for the image forming apparatus.

9. A method for causing a display unit to display, as an image, display information received from an external device and causing a print unit to print the displayed image, the method comprising:
changing content of the display information stored in a storage according to print setting information that defines print conditions to be applied when performing printing on a recording medium; and
generating a print image to be fed to the print unit, using the changed display information.

10. The method according to claim 9, wherein
the storage stores a plurality of pieces of the print setting information, and
the changing includes changing the content of the display information according to a piece of the print setting information selected by a user among the plurality of pieces of the print setting information.

11. The method according to claim 9, wherein
the storage stores a plurality of pieces of the print setting information, and
the method further comprises selecting one piece of the print setting information among the plurality of pieces of the print setting information stored in the storage depending on designation of the recording medium.

12. The method according to claim 9, wherein
the storage stores a plurality of pieces of the print setting information, and
the method further comprises selecting one piece of the print setting information among the plurality of pieces of the print setting information stored in the storage depending on the content of the display information.

13. The method according to claim 9, wherein the print setting information contains information about at least size of the image, position of the image, and presence or absence of an additional image to be displayed as being overlaid on the image.

14. The method according to claim 9, further comprising:
submitting a request for the display information to the external device; and
acquiring the display information from the external device.
